(19) United States
(12) Patent Application Publication
(10) Pub. No.: US 2024/0039157 A1
(43) Pub. Date: Feb. 1, 2024

(54) MOBILE DEVICE SUPPORTING WIDEBAND OPERATION

(71) Applicant: Acer Incorporated, New Taipei City (TW)

(72) Inventors: Kun-Sheng CHANG, New Taipei City (TW); Ching-Chi LIN, New Taipei City (TW)

(21) Appl. No.: 18/072,831

(22) Filed: Dec. 1, 2022

(30) Foreign Application Priority Data
Jul. 26, 2022 (TW) 111127881

(51) Int. Cl. H01Q 5/25; H01Q 1/24

(52) U.S. Cl. CPC H01Q 5/25; H01Q 1/245

(57) ABSTRACT

A mobile device supporting wideband operations includes an antenna structure that includes a ground element, a first radiation element, a second radiation element, a third radiation element, a fourth radiation element, and a fifth radiation element. The first radiation element has a feeding point. The second radiation element is coupled to a first grounding point on the ground element. The third radiation element is coupled to the feeding point. The first radiation element and the third radiation element are at least partially surrounded by the second radiation element. The fourth radiation element is coupled to a second grounding point on the ground element. The fourth radiation element includes a first elevated portion. The fifth radiation element is coupled to the feeding point. The fifth radiation element includes a second elevated portion.

This application claims the benefit of Taiwan Application Serial No. 111127881, filed Jul. 26, 2022, the subject matter of which is incorporated herein by reference in its entirety.

### TECHNICAL FIELD

The present invention is directed to wireless communications, and specifically to an antenna for wideband wireless communications for a mobile device.

### BACKGROUND

With the development of mobile communication technology, multi-function mobile devices such as notebook computers, mobile phones, media players, and other portable electronic devices have become increasingly popular in recent years. To meet the ever-increasing demand for mobile device functionality, and corresponding wireless bandwidth requirements, the wireless communication aspects of the overall design must continually be improved.

Wireless communication can cover a wide range of frequency bands for longer range communication. For examples 2G, 3G, LTE (Long Term Evolution), used for mobile phones, may use any one or more of the 700 MHz, 850 MHz, 900 MHz, 1800 MHz, 1900 MHz, 2100 MHz, 2300 MHz and 2500 MHz bands for communication.

Similarly, some wireless communication is designed to cover frequency bands more suitable for shorter range communication. For examples Wi-Fi and Bluetooth use the 2.4 GHz, 5.2 GHz, and 5.8 GHz bands for communication.

An antenna is a critical component in wireless communication system. If the bandwidth of the antenna for transmitting and receiving is too narrow, wireless communication quality of a mobile device may suffer.

### SUMMARY

In accordance with an embodiment, an antenna for a mobile device is provided and includes a first set of radiation elements disposed on a first plane, a second set of radiation elements disposed on a second plane, substantially parallel to the first plane, each radiation element in the second set of radiation elements being conductively connected to portions of radiation elements disposed on the first plane via projections extending between the first plane and the second plane, and a feeding point for the antenna is located on the first plane adjacent one of the projections.

In accordance with another embodiment an antenna for a mobile device is provided and includes a ground element, a first radiation element, a second radiation element, a third radiation element, a fourth radiation element, and fifth radiation element, wherein the ground element, the first radiation element, the second radiation element, and the third radiation element are disposed on a first plane, and the fourth radiation element and the fifth radiation element have portions that extend from the first plane and have portions that are arranged on a second plane, above, and substantially parallel to, the first plane.

In accordance with still another embodiment an antenna for a mobile device is provided and includes a first set of radiation elements disposed on a substrate, and a first elevated radiation element and a second elevated radiation element disposed over at least one radiation element in the first set of radiation elements, wherein the first elevated radiation element and the second elevated radiation element are each substantially L-shaped with open ends that extend towards each other.

### BRIEF DESCRIPTION OF THE DRAWINGS

Embodiments are described herein in conjunction with the accompanying drawings, in which:

FIG. 1A shows a top view of an antenna for a mobile device according to an embodiment of the present invention.

FIG. 1B is atop view showing selected components of the antenna for a mobile device according to an embodiment of the present invention.

FIG. 1C is another top view showing selected components of the antenna for a mobile device according to an embodiment of the present invention.

FIG. 1D is a three-dimensional perspective view showing the antenna for a mobile device according to an embodiment of the present invention.

FIG. 2 shows a graph of return loss for the antenna for a mobile device according to an embodiment of the present invention.

FIG. 3 shows a graph of radiation efficiency for the antenna for a mobile device according to an embodiment of the present invention.

### DESCRIPTION OF EXAMPLE EMBODIMENTS

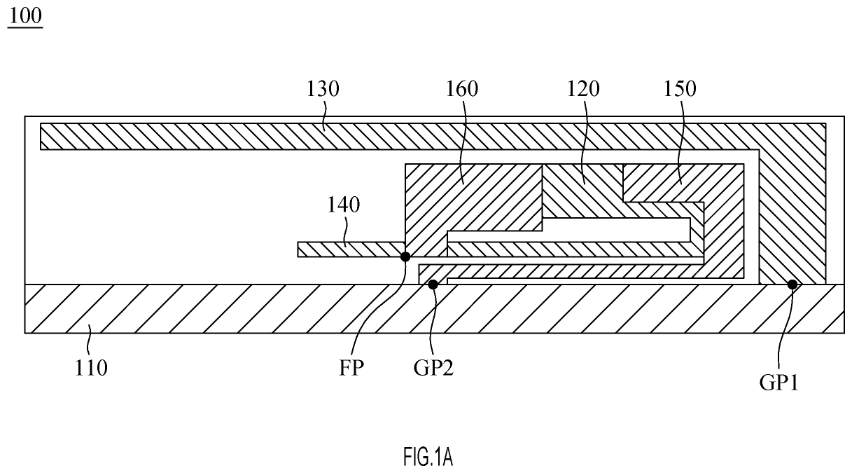

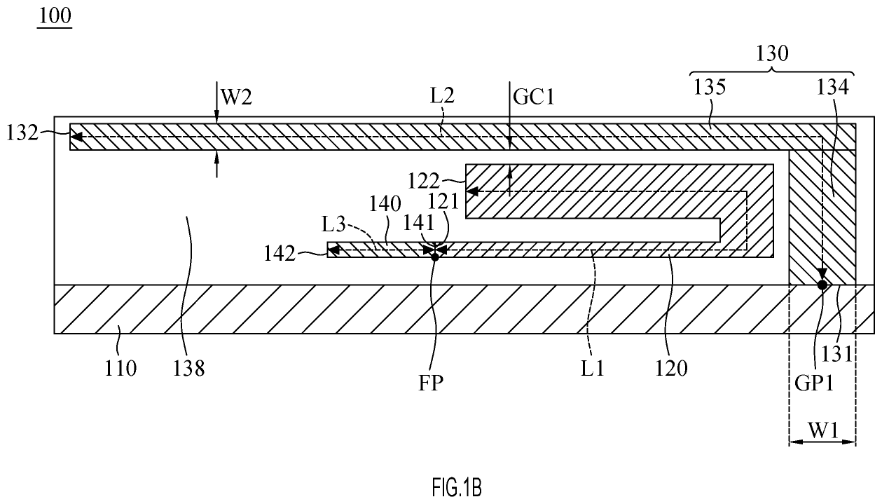

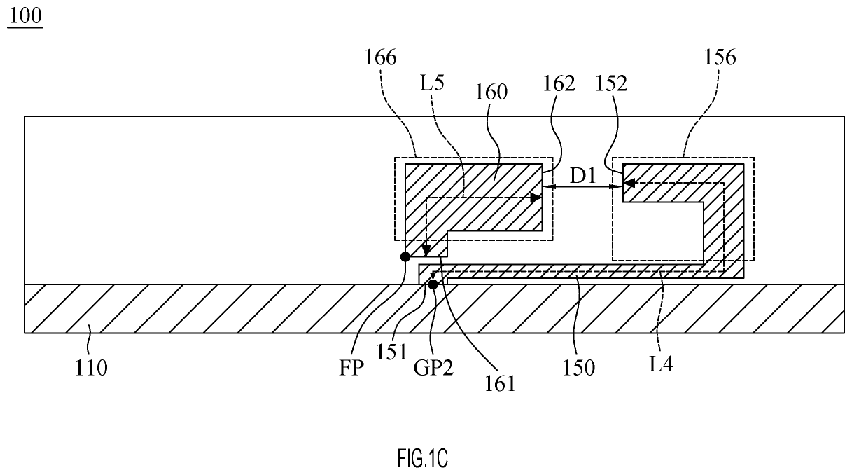

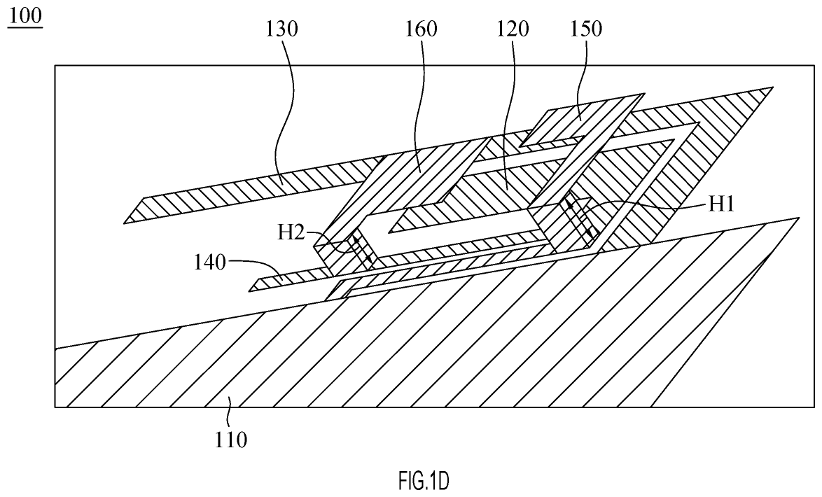

Reference is made generally to FIGS. 1A, 1B, 1C, 1D, which show top views and a perspective view of an antenna 100 for a mobile device according to an embodiment of the present invention. The antenna 100 may be used in a mobile device such as a smart phone, a tablet computer, a notebook computer, among other mobile electronic devices.

As shown in FIGS. 1A, 1B, 1C, and 1D, the antenna 100 may include a ground element 110, a first radiation element 120, a second radiation element 130, a third radiation element 140, a fourth radiation element 150, and a fifth radiation element 160, wherein ground element 110, the first radiation element 120, the second radiation element 130, the third radiation element 140, the fourth radiation element 150, and the fifth radiation element 160 may all be made of conductive metal material, such as copper, silver, aluminum, iron, etc., or alloys thereof.

Those skilled in the art will appreciate that although not shown in FIGS. 1A, 1B, 1C, and 1D, a mobile device that incorporates the antenna 100 may further include other elements or components such as, e.g., a processor, a touch control panel, a speaker, a power supply module and/or a housing.

The ground element 110 can be implemented by a ground copper foil, which can provide a ground voltage potential. In some embodiments, the ground element 110 may be further coupled to a system ground plane (not shown) of the mobile device.

The first radiation element 120 may roughly be configured in aU-shape with unequal arm widths. In other embodiments, the first radiation element 120 may have equal-width arms. The first radiation element 120 has a first-end 121 and a second-end 122, wherein a feeding point FP is located at the first-end 121 of the first radiation element 120. The second-end 122 of the first radiation element 120 is an open end.

The feeding point FP may be coupled to a signal source (not shown), such as a radio frequency (RF) module of the mobile device.

The second radiation element 130 may be configured approximately as an L-shape with unequal leg widths. Specifically, the second radiation portion 130 has a first-end 131 and a second-end 132, wherein the first-end 131 of the second radiation portion 130 is coupled to a first grounding point GP1 on the ground element 110, and the second-end 132 of the second radiation portion 130 is an open end.

As shown, both the second-end 132 of the second radiation element 130 and the second-end 122 of the first radiation element 120 may extend in the same direction.

In some embodiments, the second radiation element 130 includes a wide portion 134 which is adjacent the first-end 131, and a narrow portion 135, which is adjacent the second-end 132, wherein the narrow portion 135 may be coupled to the first ground point GP1 through the wide portion 134.

It is noted that the term “close” or “adjacent” in the present description may indicate that the distance between two corresponding elements is less than a critical distance, e.g., 10 mm or less), and may also include the situation where the two corresponding elements contact each other directly (i.e., the distance between the elements is 0 mm). In some embodiments, the second radiation element 130 is adjacent the first radiation element 120, so that a coupling gap GC1 is formed between the narrow portion 135 of the second radiation element 130 and the first radiation element 120.

The third radiation element 140 may be roughly configured as a straight bar. Specifically, the third radiation element 140 has a first-end 141 and a second-end 142, wherein the first-end 141 of the third radiation element 140 is coupled to the feeding point FP. The second-end 142 of the third radiation portion 140 is an open end. For example, both the second-end 142 of the third radiation element 140 and the second-end 122 of the first radiation element 120 may extend in the same direction.

As shown, both the first radiation element 120 and the third radiation element 140 are at least partially surrounded by the second radiation element 130.

As further shown, the second radiation element 130 and the ground element 110 can jointly define a notch region 138, and both the first radiation portion 120 and the third radiation portion 140 may be located within the notch region 138.

The fourth radiation element 150 may generally exhibit a circuitous shape. More specifically, the fourth radiation element 150 has a first-end 151 and a second-end 152, wherein the first-end 151 of the fourth radiation element 150 is coupled to a second ground point GP2 on the ground element 110. The second ground point GP2 may be different from the aforementioned first ground point GP1. The second-end 152 of the fourth radiation portion 150 is an open end.

It should be noted that the fourth radiation portion 150 includes a first elevated portion 156, which may be roughly L-shaped.

The fifth radiation element 160 has a first-end 161 and a second-end 162, wherein the first-end 161 of the fifth radiation element 160 is coupled to the feeding point FP, and the second-end 162 of the fifth radiation element of 160 is an open end.

As shown, both the second-end 162 of the fifth radiation element 160 and the second-end 152 of the fourth radiation element 150 may extend in opposite directions

The fifth radiation portion 160 includes a second elevated portion 166, which may also be roughly L-shaped.

In the depicted embodiment, the first radiation element 120, the second radiation element 130, and the third radiation element 140 are all disposed on a first plane.

The first elevated portion 156 of the fourth radiation element 150 and the second elevated portion 166 of the fifth radiation element 160 can both be located on a second plane, that is substantially parallel with the first plane. However, those skilled in the art will appreciate that the first elevated portion 156 of the fourth radiation element 150 and the second elevated portion 166 of the fifth radiation element 160 need not both be in precisely the same plane.

In some embodiments, the first elevated portion 156 of the fourth radiation portion 150 has a first vertical projection extending from the aforementioned first plane and the first vertical projection may at least partially overlap with the first radiation element 120.

In a preferred embodiment, the first radiation element 120, the second radiation element 130, the third radiation element 140, the fourth radiation element 150, and the fifth radiation element 160 jointly form the antenna 100 structure of a mobile device.

For example, the first radiation element 120, the second radiation element 130, and the third radiation element 140 may be disposed on a dielectric substrate (not shown), and the fourth radiation element 150 and the fifth radiation element 160 may be disposed on a support element (not shown), which could be conductive or non-conductive.

The aforementioned dielectric substrate or support element can be a Flame Retardant 4 (FR4) substrate, a printed circuit board (PCB), a flexible printed circuit (FPC), or a plastic fixing element.

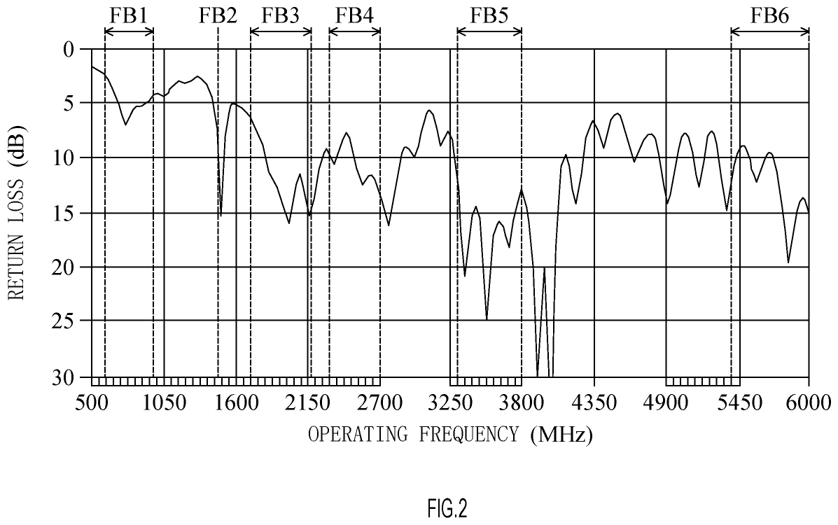

FIG. 2 shows a graph of return loss for the antenna 100 for a mobile device according to an embodiment of the present invention. In FIG. 2, the horizontal axis represents the operating frequency (MHz), and the vertical axis represents the return loss (dB).

According to the measurements represented in FIG. 2, the antenna 100 for a mobile device can cover a first frequency band FB1, a second frequency band FB2, a third frequency band FB3, a fourth frequency band FB4, a fifth frequency band FB5, and a sixth frequency band FB6.

For example, the first frequency band FB1 may be between 600 MHz and 960 MHz, the second frequency band FB2 may be at 1450 MHz, the third frequency band FB3 may be between 1710 MHz and 2170 MHz, and the fourth frequency band FB4 may be between 2300 MHz and 2700 MHz. The fifth frequency band FB5 may be between 3300 MHz and 3800 MHz, and the sixth frequency band FB6 may be between 5000 MHz and 6000 MHz.

With such frequency band coverage, the antenna 100 for a mobile device can effectively support the broadband operation of a 5th Generation Wireless System.

In some embodiments, the operation principle of the antenna 100 of a mobile device may be as follows. The first radiation element 120 can be excited to generate the aforementioned first frequency band FB1. The second radiation element 130 can be excited to generate a fundamental resonant mode which can increase the bandwidth of the aforementioned first frequency band FB1. The second radiation element 130 can further be excited to generate a higher-order resonant mode to form the aforementioned fourth frequency band FB4. The third radiation element 140 can be excited to generate another fundamental frequency resonance mode to form the aforementioned fifth frequency band FB5. The third radiation element 140 can further be excited to generate another high-order resonant mode to form the aforementioned sixth frequency band FB6.

The fourth radiation element 150 can be excited to generate the aforementioned second frequency band FB2, and the fifth radiation element 160 can be excited to generate the aforementioned third frequency band FB3.

Since the antenna 100 for a mobile device uses a three-dimensional antenna structure, the overall antenna size can be greatly reduced compared to a conventional two-dimensional antenna structure design.

In some embodiments, the component dimensions of the antenna 100 for a mobile device may be as follows.

The length L1 of the first radiation element 120 may be approximately equal to 0.25 times the wavelength (λ/4) of the first frequency band FB1 of the antenna 100.

The length L2 of the second radiation element 130 may be approximately equal to 0.25 times the wavelength (λ/4) of the first frequency band FB1 of the antenna 100.

In the second radiation element 130, the width W1 of the wide portion 134 may be between 5 mm and 7 mm, and the width W2 of the narrow portion 135 may be between 2 mm and 3 mm.

The length L3 of the third radiation element 140 may be approximately equal to 0.25 times the wavelength (λ/4) of the fifth frequency band FB5 of the antenna 100.

The length L4 of the fourth radiation element 150 may be approximately equal to 0.25 times the wavelength (λ/4) of the second frequency band FB2 of the antenna 100. The height H1 of the first elevated portion 156 of the fourth radiation element 150 extending above the first radiation element 120 may be between 5 mm and 7 mm.

The length L5 of the fifth radiation element 160 may be approximately equal to 0.25 times the wavelength (λ/4) of the third frequency band FB3 of the antenna 100. The height H2 of the second elevated portion 166 of the fifth radiation element 160 extending above the first radiation element 120 may be between 5 mm and 7 mm.

The coupling gap GC1 may be between 1 mm and 2 mm. The shortest distance D1 between the fifth radiation element 160 and the fourth radiation element 150 may be between 5 mm and 10 mm.

The above dimensions and parameters are obtained according to many experimental results, which help to optimize the operational bandwidth and impedance matching of the antenna 100. This skilled in the art, however, will appreciate that these dimensions are not meant to limit the scope of the invention, but are disclosed as one specific example.

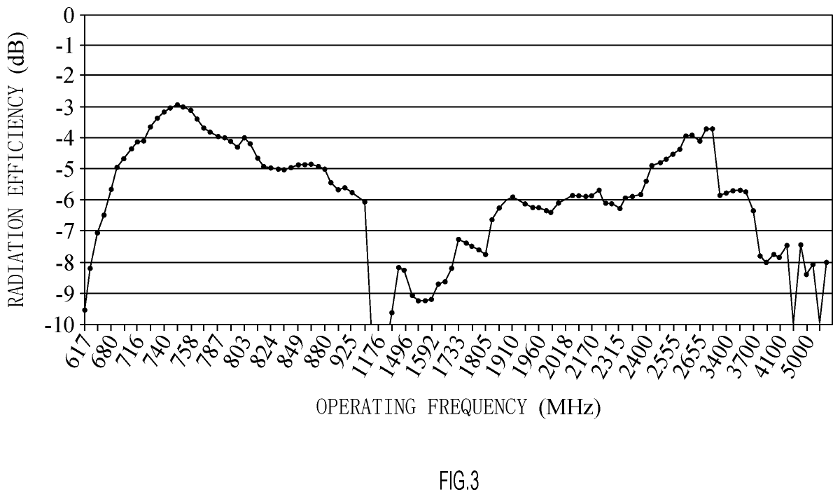

FIG. 3 shows a graph of radiation efficiency for the antenna 100 for a mobile device according to an embodiment of the present invention, wherein the horizontal axis represents the operating frequency (MHz) and the vertical axis represents the radiation efficiency (dB).

According to the measurements represented in FIG. 3, the radiation efficiency of the antenna 100 in the desired operating frequency bands can reach at least −9 dB or more. Such performance meets the practical application requirements of general mobile communication devices.

In sum, the present invention provides a novel three-dimensional antenna structure for a mobile device.

Compared to a traditional design, the present invention has many advantages including small size, wide bandwidth, high radiation efficiency, and low manufacturing cost. Accordingly, it is very suitable for mobile communication devices.

The above description is intended by way of example only.

What is claimed is:

1. An antenna for a mobile device, comprising:
a first set of radiation elements disposed on a first plane;
a second set of radiation elements disposed on a second plane, substantially parallel to the first plane, each radiation element in the second set of radiation elements being conductively connected to portions of radiation elements disposed on the first plane via projections extending between the first plane and the second plane; and
a feeding point for the antenna is located on the first plane adjacent one of the projections.

2. The antenna of claim 1, further comprising a first grounding point and a second grounding point, different from the first grounding point, each associated with different radiation elements.

3. The antenna of claim 2, wherein the first grounding point and the second grounding point are disposed on the first plane adjacent a ground element.

4. The antenna of claim 1, wherein the first set of radiation elements includes an L-shaped radiation element.

5. The antenna of claim 4, wherein the first set of radiation elements includes a U-shaped radiation element.

6. The antenna of claim 5, wherein the L-shaped radiation element partially surrounds the U-shaped radiation element.

7. The antenna of claim 5, wherein the second set of radiation elements overlap at least portions of the U-shaped radiation element.

8. The antenna of claim 1, wherein the first set of radiation elements and the second set of radiation elements, in combination, provide radio frequency coverage for bands comprising 600 MHz to 960 MHz, 1450 MHz, 1710 MHz to 2170 MHz, 2300 MHz to 2700 MHz, 3300 MHz to 3800 MHz, and 5000 MHz to 6000 MHz.

9. The antenna of claim 8, wherein a radiation efficiency across the bands is at least −9 dB.

10. The antenna of claim 1, in combination with the mobile device.

11. An antenna for a mobile device, comprising:
a ground element;
a first radiation element,
a second radiation element;
a third radiation element;
a fourth radiation element; and
fifth radiation element,
wherein the ground element, the first radiation element, the second radiation element, and the third radiation element are disposed on a first plane, and the fourth radiation element and the fifth radiation element have portions that extend from the first plane and have portions that are arranged on a second plane, above, and substantially parallel to, the first plane.

12. The antenna of claim 11, wherein the first radiation element is substantially U-shaped element.

13. The antenna of claim 12, wherein a first arm of the substantially U-shaped element is wider than a second arm of the substantially U-shaped element.

14. The antenna of claim 11, wherein the second radiation element is substantially L-shaped.

15. The antenna of claim 11, wherein the fourth radiation element comprises a portion that extends substantially perpendicularly to the first plane towards the second plane.

16. The antenna of claim 11, wherein the fifth radiation element comprises a portion that extends substantially perpendicularly to the first plane towards the second plane from the first radiation element.

17. The antenna of claim 11, wherein the second radiation element at least partially surrounds the first radiation element.

18. The antenna of claim 11, further comprising a feedpoint disposed between a first end of the first radiation element and a first end of the third radiation element.

19. An antenna for a mobile device, comprising:
a first set of radiation elements disposed on a substrate; and
a first elevated radiation element and a second elevated radiation element disposed over at least one radiation element in the first set of radiation elements,
wherein the first elevated radiation element and the second elevated radiation element are each substantially L-shaped with open ends that extend towards each other.

20. The antenna of claim 19, wherein the first set of radiation elements includes a U-shaped radiation element.
